(19) United States
(12) Patent Application Publication
(10) Pub. No.: US 2003/0161619 A1
(43) Pub. Date: Aug. 28, 2003

(54) Terrestrial telescope with digital camera

(76) Inventor: Masao Niino, Gamagori-shi (JP)

Correspondence Address: ADAMS & WILKS, 31st Floor, 50 Broadway, New York, NY, 10004, US

(21) Appl. No.: 10/261,637

(22) Filed: Sep. 30, 2002

(30) Foreign Application Priority Data
Feb. 25, 2002 (JP) 2002-047304

(51) Int. Cl. G03B 17/00

(52) U.S. Cl. 396/72

(57) ABSTRACT

A terrestrial telescope having a digital camera includes an objective lens, an imaging element located at the image-formation plane of the objective lens, and an image processing unit for processing image data captured by the imaging element for record on recording media. A return mirror is disposed between the objective lens and the imaging element to direct the beam to an erecting optical element and an adjustable ocular during observation and direct it to the imaging element during imaging. A reticle is located conjugate to the image-formation plane of the objective lens to indicate the range of the imaging element. A controller controls the return mirror in such a way that it is retracted from the optical path when it is desired to take a picture of an object, and it moves back into the optical path to enable a user to view images of target objects.

### BACKGROUND OF THE INVENTION

1. Field of the Invention

The present invention relates to a terrestrial telescope with a digital camera that can record observed images.

2. Description of the Prior Art

Terrestrial telescopes having a magnification factor ranging from about 20 to 60 are widely used for observing wild birds and other fauna. There is also a demand for the ability not only to observe, but also to record such images.

Terrestrial telescopes include those based on a Galilean telescope comprising a positive (convex) lens and a negative (concave) lens that functions as an erecting system, and those based on a Keplerian telescope comprising just a positive (convex) lens, to which are added prisms or other such elements for providing an erecting system. Both types of telescope enable a viewer to observe an erect image.

Terrestrial telescopes are generally used only for observation. If it is necessary to record the observed images, a single-lens reflex camera, or a digital camera attached to the telescope by means of a special adapter is used for recording. In the case of a single-lens reflex camera, the images are recorded while they are being observed on the camera's focusing screen. However, since the images from the focusing screen are not spatial images, they are fuzzy and dark.

When a digital camera connected to the telescope by an adaptor is used to record the images, the images are recorded while viewing the images on a liquid crystal screen. The image is, however, coarse owing to the small size of the liquid crystal screen and the small number of picture elements. In addition, when viewed under bright surrounding light conditions, the light reflecting off the liquid crystal display makes it very hard to see the images.

Images can also be recorded by using a camera with a super telephoto lens. However, the images obtained with this method are also fuzzy and dark because the images are recorded while being viewed on the focusing screen. Moreover, super telephoto lenses that enable acquisition of an image with around the same magnification as a terrestrial telescope are very expensive.

Thus, whichever method is used, there is no terrestrial telescope that can be used to observe a bright, clear image and at the same time makes it possible to record the same image.

An object of the present invention is to provide a terrestrial telescope having a digital camera that, during observation, can obtain a bright, clear image like an ordinary terrestrial telescope and can readily record the observed image as an electronic image.

### SUMMARY OF THE INVENTION

The present invention provides a terrestrial telescope having a digital camera, which comprises an objective lens; an imaging element disposed at an image-formation plane of the objective lens; an image processing unit for processing image data from the imaging element for record on recording media; an optical path deflector that is retractably disposed between the objective lens and the imaging element; an erecting optical element disposed on an optical axis deflected by the optical path deflector to provide an erecting optical system in cooperation with the optical path deflector; an ocular adjustable depending upon the observer's diopter for observing an spatial erect image of a subject formed by the erecting optical element at a position that is a conjugate of the image-formation plane of the objective lens; a reticle disposed at a position that is a conjugate of the image-formation plane of the objective lens to indicate the imaging range of the imaging element; and means for controlling the optical path deflector in such a way that, during observation, it lies in a position to deflect an optical path to the erecting optical element to thereby enable an observer using the ocular to view an erect image of a subject as a spatial image and, during imaging, it lies in the retracted position to direct the optical path to the imaging element whose image data is processed in the image processing unit for record on recording media.

The objective lens used in such an arrangement can be a zoom lens.

Further features of the invention, its nature and various advantages will be more apparent from the accompanying drawings and following detailed description of the invention.

### BRIEF DESCRIPTION OF THE DRAWINGS

FIG. 1 is an illustrative view showing an optical system used for a terrestrial telescope with a digital camera according to the present invention.

### DESCRIPTION OF THE PREFERRED EMBODIMENTS

The invention will now be described with reference to the drawing, which shows one embodiment of a terrestrial telescope with a digital camera according to the invention.

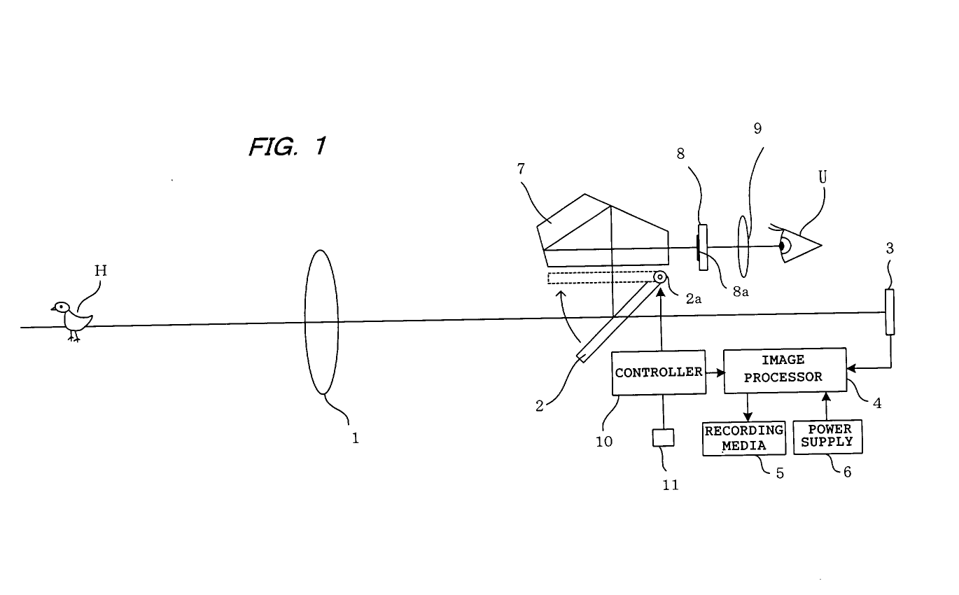

In FIG. 1, reference numeral 1 denotes a zoom objective lens having a focal distance that can be adjusted from 140 mm to 420 mm. For simplification, the zoom objective lens 1 is shown in FIG. 1 as a single lens. The zoom objective lens 1 can be arbitrarily comprised and driven, but is required to at least be able to be zoomed and focused by an external operation, using a motor drive or a manual drive. Moreover, while the following explanation is made with reference to a zoom objective lens, it is not essential for the lens 1 to be a zoom lens.

A return mirror 2 serving as an optical path deflector or optical path divider is disposed on the optical axis of the zoom objective lens 1 at an angle of 45 degrees to the optical path. The return mirror 2 is supported so that it can rotate about an axis 2a. The return mirror 2 is normally in the position indicated by the solid line, but during imaging a spring or other such drive means is used to retract the mirror 2 to the position indicated by the broken line. Thus, the return mirror 2 is operated by the same type of drive system used to operate the quick-return mirror of a single-lens reflex camera.

Positioned to the rear of the return mirror 2 is a CCD (camera) 3 that serves as an imaging element used for obtaining digital images. Images produced by means of the zoom objective lens 1 are formed on the CCD 3. Provided above the return mirror 2 is a penta roof prism 7 that deflects the optical path horizontally. The penta roof prism 7 and return mirror 2 function as an erecting optical system that forms a subject image produced by the zoom objective lens 1 into an erect image. A reticle 8 that indicates the imaging range of the CCD 3 is provided at a position that is a conjugate of that of the CCD 3. An ocular 9 having a focal distance of, for example, 7 mm is disposed to the rear of the reticle 8. The ocular 9 can be moved back and forth along the optical axis to adjust the diopter of an observer U.

The image 8a of a subject H, a wild bird in this example, is formed at the position of the reticle 8 and, via the ocular 9, can be viewed by the observer U as a virtual, spatial erect image. Image data from the CCD 3 is input to an image processing unit 4 for processing the image data from the CCD 3 for record on a recording media 5. The image processing unit 4 is well known, so that its detailed description is omitted. The recording media 5 may be arbitrarily selected from among such storage media as memory cards, semiconductor cards, PC cards and flexible disks, and so forth.

Reference numeral 10 denotes a controller comprised of a microprocessor, memory, chip-sets and other such component parts. In response to the operation of a shutter button 11 the controller 10 controls the return mirror 2 and the image data reading via the CCD 3. Reference numeral 6 denotes a power supply used to drive the above electronic circuitry. The power supply 6 is usually a battery or the like.

A terrestrial telescope with such an arrangement will be operated as follows. First, the ocular 9 has to be adjusted in adaptation for the diopter of the user. For this the ocular 9 is adjusted until the user can clearly see the field-of-view frame of the reticle 8 or a pattern. The optical system is designed so that, when the diopter adjustment has been completed and the image viewed through the ocular 9 is clear, a clear image can also be formed on the CCD 3.

For the sake of the explanation, it is assumed that the telescope is being used for bird-watching and the bird-watcher (the user) has found a desired subject H (a wild bird) in the distance. In such a case, the user will point the telescope at the bird with the zoom objective lens 1 set to the shortest focal distance, which is 140 mm in the case of the example of this embodiment. The light entering the zoom objective lens 1 is deflected upward by the return mirror 2 and horizontally by the penta roof prism 7, and forms an erect image 8a on the reticle 8. By using the ocular 9, the image can be viewed at a magnification of ×20. In this wide-angle zoom state, it is relatively easy to bring the bird into the field of view.

With the bird maintained in the center of the field of view, the magnification can be increased to ×60 by increasing the focal distance of the zoom objective lens 1 to 420 mm. If desired, the shutter button 11 can be pressed at this point to record an image of the bird. The operation of the shutter button 11 causes the controller 10 to activate a solenoid or other such drive element (not shown) to retract the return mirror 2 up to the position shown by the broken line and to read the image data from the CCD 3 and transmit it to the image processing unit 4 to record the image on the recording media 5.

In this way, the image of the bird can be captured and recorded on the recording media 5 by means of the image processing unit 4. The image data can be stored in any desired format, such as non-compressed bitmap data or in a compressed file format such as JPEG or GIF or the like. The image cannot be viewed while the return mirror 2 is in the retracted position. However, after the CCD 3 has captured the desired images, a motor or other such drive means is used to return the mirror 2 back to the position shown by the solid line. This allows viewing to be resumed.

Unlike in a conventional system using a single-lens reflex camera in which the observed image is formed on the focusing screen, or in a conventional system using a digital camera in which the image is viewed on a display device such as an LCD, the system of the present invention includes an erecting system to enable the user to view the spatial erect image formed at the reticle via the ocular and also includes the CCD camera disposed at the conjugate position of the erect image to capture the viewed image date for record on the recording media when the return mirror is swung up. This enables direct viewing of sharp and bright erect images as is the case with the terrestrial telescope and prompt recording in the form of digital image data on recording media.

The optical system described in the context of the foregoing embodiment is only one example, and the components or elements used can be modified or changed by a person skilled in the art. For example, another optical system can be used to form the erecting optical system instead of the above-described combination of penta roof prism and return mirror.

As described in the foregoing, the terrestrial telescope with the digital camera according to the present invention allows the user to view the sharp and bright spatial erect image formed by the objective lens without using conventional means such as a focusing screen or LCD and to promptly record the observed images using an imaging element located at a position that is a conjugate to that of the spatial image.

What is claimed is:

1. A terrestrial telescope having a digital camera, comprising:
an objective lens;
an imaging element disposed at an image-formation plane of the objective lens;
an image processing unit for processing image data from the imaging element for record on recording media;
an optical path deflector that is retractably disposed between the objective lens and the imaging element;
an erecting optical element disposed on an optical axis deflected by the optical path deflector to provide an erecting optical system in cooperation with the optical path deflector;
an ocular adjustable depending upon the observer's diopter for observing an spatial erect image of a subject formed by the erecting optical element at a position that is a conjugate of the image-formation plane of the objective lens;
a reticle disposed at a position that is a conjugate of the image-formation plane of the objective lens to indicate the imaging range of the imaging element; and
means for controlling the optical path deflector in such a way that, during observation, it lies in a position to deflect an optical path to the erecting optical element to thereby enable an observer using the ocular to view an erect image of a subject as a spatial image and, during imaging, it lies in the retracted position to direct the optical path to the imaging element whose image data is processed in the image processing unit for record on recording media.

2. A terrestrial telescope with digital camera according to claim 1, wherein the objective lens is a zoom lens.
